(19) United States
(12) Patent Application Publication
(10) Pub. No.: US 2015/0285305 A1
(43) Pub. Date: Oct. 8, 2015

(54) METHOD OF FORMING SHEET METAL BEARING CAGE WITH INNER AND OUTER RETENTION AND ROLLER-CAGE ASSEMBLY FOR A BEARING

(71) Applicant: Schaeffler Technologies AG & Co. KG, Herzogenaurach (DE)

(72) Inventors: Seth Claus, Charlotte, NC (US); Dennis Roffe, Fort Mill, SC (US)

(73) Assignee: SCHAEFFLER TECHNOLOGIES AG & CO. KG, Herzogenaurach (DE)

(21) Appl. No.: 14/631,989

(22) Filed: Feb. 26, 2015

Related U.S. Application Data
(60) Provisional application No. 61/974,525, filed on Apr. 3, 2014.

(51) Int. Cl. F16C 33/54; B21D 53/12; B23P 15/00; F16C 19/26; F16C 43/08

(52) U.S. Cl. CPC F16C 33/543; F16C 19/26; F16C 43/083; F16C 33/541; B23P 15/003; B21D 53/12

(57) ABSTRACT

A cage for rolling elements of a radial roller bearing is provided having first and second axial flanges spaced from each other by cage bars that extend therebetween that form a plurality of roller pockets. Retention scallops that extend axially inwardly are defined in each of the first and second axial flanges, generally centered about the cage bars, and the cage bars are located radially inwardly of a pitch circle of the rolling elements. The retention scallops extend axially inwardly at a position radially outward from the pitch circle to a position where portions of each of the retention scallops axially overlap end portions of adjacent rolling elements. A method of forming the cage and cage-roller assembly are also provided.

### INCORPORATION BY REFERENCE

The following documents are incorporated herein by reference as if fully set forth: U.S. Provisional Application No. 61/974,525, filed Apr. 3, 2014.

### FIELD OF INVENTION

The present invention relates to roller bearings, and in particular to sheet metal cages for roller bearings that function to maintain the spacing between the rollers as well as to retain the rollers for handling.

### BACKGROUND

Roller bearings are typically comprised of needle, cylindrical, or tapered rolling elements that are circumferentially spaced apart by a cage, and assembled with inner and/or outer races. Alternatively, the rollers and cage may be installed directly on a shaft that acts as the inner race that is then slid into an outer race or housing. Known cage assemblies include a first flange, a second flange, and web-like cage bars that connect the first flange and the second flange. Other various cage profiles, including straight cages and cages which resemble the letters W, M, V, A, and U in axial cross-section, are known and used in radial roller bearing applications. A straight cage or a cage having a U-profile is used with rolling elements of limited length. However, these cages do not provide a portion of the cage bar for the rolling elements to push against at or near the pitch circle of the rollers. The current production cages also generally do not maintain a portion of the cage bar at or above the bearing pitch and at or below the bearing pitch while maintaining rolling element retention. This is an issue that prevents pre-assembly of rollers in a cage.

Radial roller bearings requiring both inner and outer retention (i.e., rolling element and cage assemblies) are typically manufactured with M-profile or W-profile cages. However, for applications of limited width, M-profile or W-profile cages cannot be used because those cage profiles are not conducive to the reduction of cage width. Neither the M-profile cage nor the W-profile cage is wide enough to have both inner retention and outer retention and/or cannot be manufactured.

### SUMMARY

Briefly stated, a cage for rolling elements of a radial roller bearing is provided. The cage includes a first axial flange, a second axial flange spaced from the first axial flange, and cage bars extending between the first axial flange and the second axial flange that form a plurality of roller pockets. The cage bars, together with the first axial flange and the second axial flange, form a U-shape in cross-section. Retention scallops that extend axially inwardly are defined in each of the first and second axial flanges, generally centered about the cage bars. The cage bars are located radially, inwardly of a pitch circle defined by the axes of the rolling elements. The retention scallops extend axially inwardly at a position radially outwardly from the pitch circle to a position where portions of each of the retention scallops axially overlap end portions of adjacent rolling elements.

Preferably, rolling elements are arranged in each of the roller pockets, with the rolling elements being retained in position via the cage bars located generally radially inwardly of the pitch circle and the portions of each of the retention scallops that axially overlap end portions of adjacent rolling elements. This allows the rolling elements to be maintained in the pockets in a radially inward direction so that they cannot fall out of the cage, as well as in a radially outward direction.

In a preferred aspect of the invention, the rolling elements have tapered or rounded ends and the portion of the retention scallops at least partially overlap the tapered or rounded ends of the rolling elements.

In a particularly preferred embodiment, the cage is integrally formed from a single piece of material preferably sheet metal. In a particularly preferred embodiment, the sheet metal is steel.

In another aspect, a method of forming a cage for rolling elements of a radial roller bearing is provided. The method includes forming a cage ring with a first axial flange and a second axial flange spaced from the first axial flange, with cage bars extending between the first axial flange and the second axial flange that form a plurality of roller pockets. The cage bars together with the first flange and second flange form a U-shape in cross-section. Retention scallops that extend axially inwardly are formed in each of the first and second axial flanges. The retention scallops are generally centered about the cage bars, and the cage bars are located radially inwardly of a pitch circle defined by the axes of the rolling elements. The retention scallops extend axially inwardly at a position radially outwardly from a pitch circle to a position where portions of each of the retention scallops axially overlap end portions of adjacent rolling elements.

Preferably, the forming of the retention scallops further comprises punching or bending the first and second axial flanges axially inwardly toward one another.

In a further aspect of the method, rolling elements are snapped into the roller pockets by elastically deforming the cage. This allows the rolling elements to be retained both inwardly and outwardly in the cage. Further, the method allows a sheet metal cage to be formed in a simple and effective manner that provides for both inward and outward retention of the rolling elements.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1 is perspective view of a rolling element-cage assembly in accordance with a preferred embodiment of the invention.

FIG. 2 is an axial end view of the rolling element-cage assembly shown in FIG. 1, partially broken away.

FIG. 3 is a partial side view of the rolling element-cage assembly of FIG. 1.

FIG. 4 is an enlarged portion of the side view shown in FIG. 3.

FIG. 5 is an enlarged partial perspective view, partially broken away, of the rolling element-cage assembly of FIG. 1.

FIG. 6 is a partial cross-sectional view showing the rolling element-cage assembly of FIG. 1 installed between inner and outer races to form a radial bearing.

### DETAILED DESCRIPTION OF THE PREFERRED EMBODIMENTS

Certain terminology is used in the following description for convenience only and is not limiting. The words “front,” “rear,” “upper” and “lower” designate directions in the drawings to which reference is made. The words “radially inwardly” and “radially outwardly” refer to directions radially toward and away from an axis of the part being referenced. “Axially” refers to a direction along the axis of a shaft or other part. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

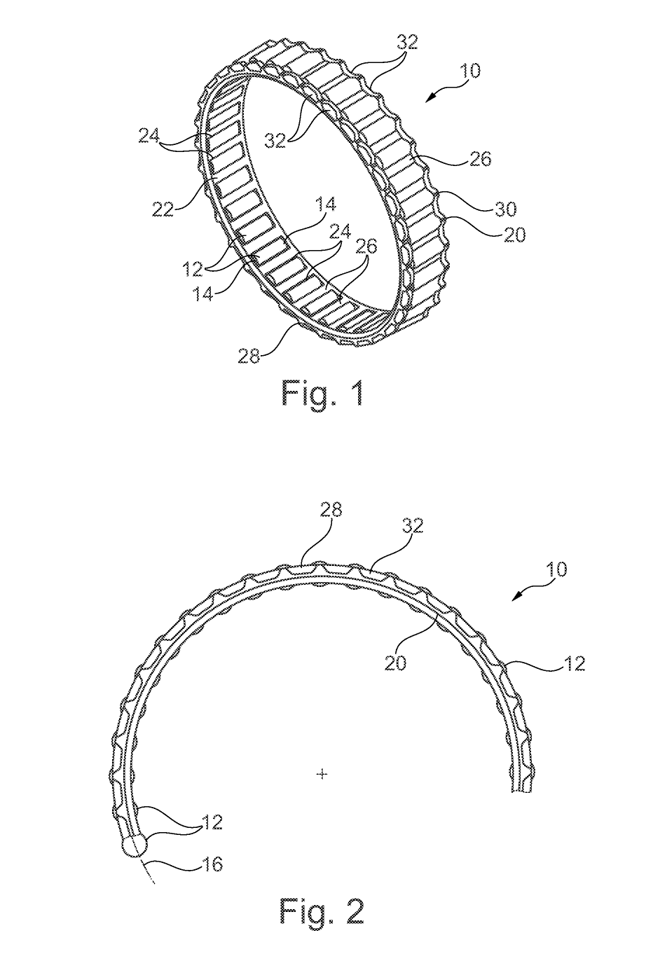

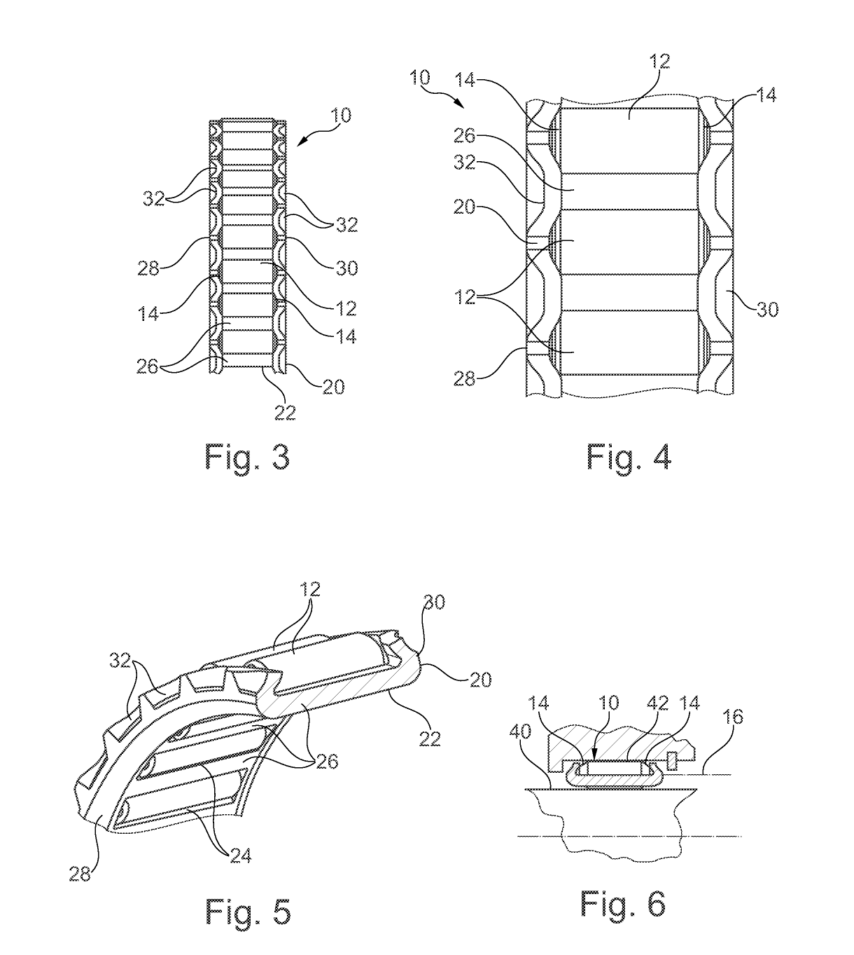

Referring to FIG. 1, a roller-cage assembly 10 according to the present invention for rolling elements 12, preferably in the form of cylindrical rollers, of a radial roller bearing is shown. The rollers 12 are held via a cage 20 formed by a cage ring 22 having first and second axial flanges 28, 30 that extend from the cage ring 22, with cage bars 26 extending between the first and second axial flanges 28, 30 to form a plurality of roller pockets 24. The cage bars 26, together with the first and second axial flanges 28, 30, form a U-shape in the cross-section, best illustrated in FIGS. 5 and 6. Retention scallops 32 that extend axially inwardly toward each other are defined in each of the first and second axial flanges 28, 30. The retention scallops 32 are generally centered about the cage bars 26, as best shown in FIG. 4. As shown in FIG. 2, the rolling elements 12 are located about a pitch circle 16 that extends through the axes of the rolling elements 12, with the pitch circle 16 being indicated in FIGS. 2 and 6. The cage bars 26 are located radially inwardly of the pitch circle 16 of the rolling elements 12 and, as shown in FIGS. 5 and 6, the retention scallops 32 extend axially inwardly at a position radially outward from the pitch circle 16 to a position where portions of each of the retention scallops 32 axially overlap end portions of adjacent ones of the rolling elements 12 at each end of the rollers 12.

As best seen in FIGS. 5 and 6, the cage bars 26 are arranged radially inwardly relative to the pitch circle 16 so that the rolling elements are maintained in the pockets 24 in the radially inward direction and cannot fall out of the cage.

As best seen in FIGS. 4 and 6, preferably the rolling elements 12 have tapered or rounded ends 14 and the portions of the retention scallops 32 at least partially overlap these tapered or rounded ends 14 of the rolling elements 12. While rolling elements 12 are shown in each of the pockets 24, it is also possible to locate rolling elements 12 in less than all of the pockets 24, for example, every second or third pocket.

Preferably, the cage 20 is integrally formed from a single piece of material. In a preferred embodiment, the cage is made of sheet metal, preferably sheet steel. Those skilled in the art will recognize that other materials could be utilized, if desired.

The retention scallops 32 are dimensioned such that the rolling elements 12 can be snapped into position in to each of the pockets 24 by elastically deflecting the cage ring 22, the bars 26 and/or the first and second axial flanges 28, 30. Once snapped into position, the cage 20 holds the rolling elements 12 in position so that they are retained both inwardly and outwardly in the radial direction allowing for pre-assembly and handling prior to assembly, for example between an inner race 40 and an outer race 42, for example, as shown in FIG. 6.

The present invention also provides a method of forming a cage 20 for rolling elements 12 of a radial roller bearing. The method includes forming a cage ring 22 with the first and second axial flanges 28, 30 which are spaced apart from one another, with cage bars 26 extending between the first axial flange 28 and the second axial flange 30 that form a plurality of roller pockets 24. The cage bars 26, together with the first and second axial flanges 28, 30 form a U-shape in cross-section. Retention scallops 32 that extend axially inwardly are formed in each of the first and second axial flanges 28, 30. The retention scallops 32 are generally centered about the cage bars 26. The cage bars 26 are located radially inwardly of a pitch circle of the rolling elements 12, and the retention scallops 32 extend axially inwardly from the opposing first and second flanges 28, 20 in a position radially outward of the pitch circle of the rolling elements 12 to a position where portions of each of the retention scallops 32 axially overlap end portions of adjacent rolling elements 12.

Preferably, in order to form a rolling element-cage assembly 10, rolling elements 12 are snapped into the roller pockets 24 by elastically deforming the cage 20.

Preferably, the cage 20 is formed from sheet metal, and the forming of the retention scallops 32 comprises punching or bending the first and second axial flanges 28, 30 axially inwardly toward one another.

Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A cage for rolling elements of a radial roller bearing, comprising: a first axial flange; a second axial flange spaced from the first axial flange; and cage bars extending between the first axial flange and the second axial flange that form a plurality of roller pockets, the cage bars, together with the first axial flange and the second axial flange forming a U-shape in cross-section, and retention scallops that extend axially inwardly defined in each of the first and second axial flanges, generally centered about the cage bars, the cage bars being located radially inwardly of a pitch circle of the rolling elements, and the retention scallops extending axially inwardly at a position radially outward from the pitch circle to a position where portions of each of the retention scallops axially overlap end portions of adjacent rolling elements.

2. The cage of claim 1, further comprising a rolling element arranged in at least some of the roller pockets.

3. The cage of claim 2, wherein the cage bars are arranged relative to the pitch circle so that the rolling elements are maintained in the pockets in a radially inward direction and cannot fall out of the cage.

4. The cage of claim 2, wherein the rolling elements have tapered or rounded ends, and the portions of the retention scallops at least partially overlap the tapered or rounded ends of the rolling elements.

5. The cage of claim 1, wherein the cage is integrally formed from a single piece of material.

6. The cage of claim 1, wherein the cage is formed from sheet metal.

7. A method of forming a cage for rolling elements of a radial roller bearing, the method comprising:
forming a cage ring with a first axial flange and a second axial flange spaced from the first flange, and cage bars extending between the first axial flange and the second axial flange that form a plurality of roller pockets, the cage bars, together with the first axial flange and the second axial flange forming a U-shape in cross-section; and
forming retention scallops that extend axially inwardly in each of the first and second axial flanges, the retention scallops being generally centered about the cage bars, the cage bars being located radially inwardly of a pitch circle of the rolling elements, and the retention scallops extending axially inwardly at a position radially outwardly from a pitch circle of the rolling elements to a position where portions of each of the retention scallops axially overlap end portions of adjacent rolling elements.

8. The method of claim 7, wherein the forming of the retention scallops further comprises punching or bending the first and second axial flanges axially inwardly toward one another.

9. The method of claim 7, further comprising snapping rolling elements into the roller pockets by elastically deforming the cage.
